(19) United States
(12) Patent Application Publication
(10) Pub. No.: US 2008/0091864 A1
(43) Pub. Date: Apr. 17, 2008

(54) INFORMATION PROCESSING UNIT

(75) Inventor: Naoki Otsuka, Konan-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/848,018

(22) Filed: Aug. 30, 2007

(30) Foreign Application Priority Data
Aug. 30, 2006 (JP) 2006233084

(51) Int. Cl. G06F 13/14; G06F 3/048

(52) U.S. Cl. 710/200; 715/764

(57) ABSTRACT

When one port is used by two or more software; even if execution of the software is inhibited, the port cannot be closed, and the protection against illegal accesses is not satisfactory. Accordingly, the invention provides each of information processing units with a setting device capable of directly setting validity or invalidity of each of the ports. In case the Web server uses the port No. 80 and the port No. 443, for example, it becomes possible, while protecting from illegal accesses by closing the port No. 80, to execute the Web server by using the port No. 443. If necessary, it becomes possible, while protecting from illegal accesses by closing the port No. 443, in reverse, to execute the Web server by using the port No. 80. Thus, both the protection and the utilization of the information processing unit can be made compatible.

### CROSS-REFERENCE TO RELATED APPLICATION

This application claims priority to Japanese Patent Application No. 2006-233084, filed on Aug. 30, 2006, the contents of which are hereby incorporated by reference into the present application.

### BACKGROUND OF THE INVENTION

1. Field of the Invention

The present invention relates to an information processing unit capable of communicating with other information processing units by way of a network circuit.

2. Description of the Related Art

Recent developments are in the technical field that an information processing unit communicates with other information processing units by way of a network circuit. Generally, the information processing unit executes plural types of software. Therefore the information processing unit is usually finished with a plurality of ports in order to communicate between the plural types of software and the network circuit.

As an example, there is an information processing unit that executes software functioning as a Web server, software functioning as an IPP, and software functioning as a WebDAV. In this case, for example, the Web server communicates with the network circuit via the port No. 80. The IPP communicates with the network circuit via the port No. 631, and the WebDAV communicates with the network circuit via the port No. 80. The port here may be a hardware that can be distinguished from other ports, which however is realized by software in general.

The information processing unit is widely used in various fields; and there can be a demand of making a part of plural types of software executable and making the remaining parts unexecutable. To meet such a demand, there is a well-known information processing unit in which it is possible to set software into execution enable or execution disable by each type of the software. According to this information processing unit, a manager of the information processing unit can set the Web server into execution enable and set the IPP into execution disable, for example. In this case, the Web server is set valid, and the IPP is set invalid.

In contrast to this, a router can also set the software into execution enable or execution disable. If the router invalidates the port No. 80 used by the Web server, the Web server of the information processing unit connected to the router through a LAN cable cannot be used from the outside of the LAN. The router capable of setting each port to be valid or invalid is disclosed in the following website of http://bb.watch.impress.co.jp/column/review/2003/04/09/.

As described above, if the information processing unit is provided with a setting device that sets each of the software into execution enable or execution disable, the setting device can make necessary software usable and make unnecessary software unusable, so as to meet the use of individual information processing units.

Also as described above, if the router is provided with a setting device that sets each port to be valid or invalid, it will be possible to make the software using the valid port usable and make the software using the invalid port unusable. However, the setting is made all at once to all the information processing units connected to the router trough the LAN cable, and it is impossible to make necessary software usable and make unnecessary software unusable, so as to meet the use of individual information processing units.

### BRIEF SUMMARY OF THE INVENTION

As being clear from the above, in order to set individual information processing units so as to meet the use of the individual information processing units, it is preferable to provide each of the information processing units with a setting device that switches each of plural types of software into execution enable or execution disable.

There is a case that each of the software is in one-to-one correspondence with the port number. As an example, the software functioning as the FTP uses the port No. 21, the software functioning as the telnet uses the port No. 23, the software functioning as the SMTP uses the port No. 25, the software functioning as the POP3 uses the port No. 110, and so forth. In this case, to switch one of the software into execution disable will substantially close the port that the software uses. In order to protect the information processing unit from illegal accesses, an effective measure is to close the port to thereby reject the illegal accesses. If each of the software is in one-to-one correspondence with the port number, by setting software using the port to be invalidated into execution, the port to be protected from the illegal accesses can be set closed. As far as each of the software is in one-to-one correspondence with the port number, there have not been any special problems.

There is a case of applying a protocol to a plural types of software as a transport protocol. Accordingly, some recent information processing units are developed in a manner that a piece of software uses two or more ports. In reverse, there appears a case that one port is used by two or more types of software. As an example, there is a case that the Web server uses the port No. 80 and the IPP uses the port No. 80 and the port No. 631. In this case, the port No. 80 is used by both the Web server and the IPP.

In this case, if the Web server is put into execution disable, since the IPP uses the port No. 80, it is impossible to close the port No. 80. The manager may intend to close the port No. 80 in order to protect the information processing unit from illegal accesses by putting the Web server into execution disable; however in reality, the IPP uses the port No. 80, and it is impossible to close the port No. 80; in short, a measure for protecting the information processing unit from the illegal accesses by closing the port No. 80 cannot be taken in practice.

Or in reverse, of the port No. 80 and the port No. 631 that the IPP uses, there is a case that a measure for protecting the information processing unit from the illegal accesses by closing the port No. 80 is required; however the same measure by closing the port No. 631 is not required. Even if the information processing unit is provided with a setting device that switches each of the software into execution enable or execution disable, this measure cannot meet the demand that wishes to maintain execution of the IPP using the port No. 631, while protecting the information processing unit from the illegal access by closing the port No 80.

If the router is provided with a setting device that sets each of the ports into being valid or invalid, there will not appear the above inconveniences. However, this measure involves setting all the information processing units connected to the router through the LAN cable all at once, it is impossible to set the information processing units individually so as to meet the individual use of them, and the user feels troublesome. This has become more and more conspicuous along with an increase of the information processing units inside the LAN.

The present invention has been made to cope with the above problems, and provides a technique that sets information processing units individually so as to meet the use of the individual information processing units, and sets each of the ports into being valid or invalid by each of the information processing units.

The present invention relates to an information processing unit capable of communicating with other information processing units by way of a network circuit.

The information processing unit according to the invention comprises: a storage device that stores software; a processing device that executes the software; a plurality of ports that make communications possible between the software and the network circuit. The information processing unit also comprises a setting device that sets validity or invalidity to each of the ports; and a controller. The controller validates execution of the software via a port, on condition that the port is set valid, and invalidates execution of the software via a port, on condition that the port is set invalid.

As a result, the information processing unit of the present invention can set, to the software using a plurality of ports, a state that the software via a port is executable and a state that the software via the other port is unexecutable. The state may be changed depending a kind of port.

If the Web server uses the port No. 80 and the port No. 443, for example, according to the information processing unit of the present invention, while protecting the information processing unit from the illegal accesses by closing the port No. 80, it is possible to execute the Web server via the port No. 443. If necessary, while protecting the information processing unit from the illegal accesses by closing the port No. 443, in reverse, it is possible to execute the Web server via the port No 80. If necessary, it is possible to close both the port No. 80 and the port No. 443. In this state, it is possible to execute the Web server under condition that communication between the information processing unit and network circuit is prohibited.

In the information processing unit of the present invention, it is possible to set individual information processing units independently from the other information processing units, even when two or more information processing units are connected to one and the same router through a LAN cable. Such a setting becomes possible that closes the port No. 80 as to the information processing unit 1 and opens the port No. 80 as to the information processing unit 2.

Using this information processing unit will make both protection and utilization of the network system compatible.

The information processing unit usually stores plural types of software. In this case, preferably, the information processing unit is provided with another setting device that switches the software into execution enable or execution disable (that is, validity or invalidity) by each type of the software. In case the information processing unit is provided with this additional or second setting device, the controller controls both execution enable or execution disable (that is, validity or invalidity) by the type of software, and validity or invalidity by the kind of port.

When the second setting device is added which switches the software into execution enable or execution disable by the type of software, it is possible to control both execution enable or execution disable by the type of software and validity or invalidity by the kind of port. When both the Web server and the IPP use the port No. 80 and the port No. 443, for example, it is possible to set a state that executes the Web server with the port No. 80 closed and the port No. 443 opened, and to set the execution of the IPP itself into a disable state. Various setting states can be realized by controlling both execution enable or execution disable by the type of software and validity or invalidity by the kind of port.

When plural types of software use one and the same port, here are combinations of the types of software and the kinds of port. When both the Web server and the IPP use the port No. 80 and both the Web server and the IPP use the port No. 443, there are four kinds of combinations, that is, (Web server and port No. 80), (Web server and port No. 443), (IPP and port No. 80), and (IPP and port No. 443).

In his case, it is preferable to provide a setting device that sets validity or invalidity to each of the combinations of the types of software and the kinds of port.

In the above case, for instance, it is possible to set the port No. 80 opened in the communication with the Web server, and to set the port No. 80 closed in the communication with the IPP, although the port number is the same 80. Thus, it becomes possible to manage each of the information processing units in detail.

If necessary, it is possible to provide the setting device with a setting function in which the port may be set valid or invalid depending on a communication direction. For instance, one port may be set valid as to the communication from the network circuit to the information processing unit, and the same port may be set invalid as to the communication from the information processing unit to the network circuit. The same port also may be set invalid as to the communication from the network circuit to the information processing unit, and may be set valid as to the communication from the information processing unit to the network circuit.

The present invention provides a novel user interface that a user uses in changing the setting state of the information processing unit. The user interface includes a display device that displays a list of kinds of ports available to the information processing unit, and executable types of software by the information processing unit. In the list, each of the executable types of software is associated with a list of kinds of ports that the type of the software uses. Alternatively, each kind of the ports may associated with a list of types of software that use the kind of port. The list may be sorted by the port or software.

The user interface also includes an inputting device for a user to select a port from the displayed list and to set validity or invalidity of the selected port. A mouse whereby a user moves the cursor on the displayed list and clicks can be used for the above inputting device, which is not especially restricted.

The present invention also provides a novel program. The program can be read by an information processing unit capable of communicating with other information processing units by way of a network circuit. The program makes the information processing unit execute the following processes:

a storage process that stores software;

an operating process that executes the software;

a setting process that sets to each of plural ports that make communications possible between the software and the network circuit, validity or invalidity; and

a controlling process that validates execution of the software via a port on condition that the port is set valid, and invalidates execution of the software via a port on condition that the port is set invalid.

Another program created by the present invention can also be read by an information processing unit capable of communicating with other information processing units by way of a network circuit. The program makes the information processing unit execute the following processes:

a displaying process that displays a list of kinds of ports available to the information processing unit and executable types of software by the information processing unit, in the list, each type of software being associated with kinds of ports that the software uses, or each kind of ports being associated with types of software that uses the kind of port;

a setting process that, on condition that a user has added an operation of selecting a kind of port from the displayed list to set validity or invalidity, validates or invalidates the kind of port with the operation added.

Using these programs will set validity or invalidity by each kind of the ports of the information processing unit. When the software uses a plurality of ports, it is possible to set a state that the software using a certain port is executable and a state that the software using another port is unexecutable.

According to the present invention, the user interface that a user operates to set validity or invalidity of individual ports of individual information processing units is provided, so that it becomes possible to set validity or invalidity of the individual ports of the individual information processing units. The present invention also realizes the program that sets validity or invalidity of the individual ports of the individual information processing units.

Even if plural information processing units are connected to one and the same router, it is possible to independently set validity or invalidity of the individual ports by each of the individual information processing units, thus achieving a setting state suitable for the use of the individual information processing units.

As the result the validity or invalidity of execution of the software using the plural ports can be set by the validity or invalidity of the ports. When the IPP uses the port No. 80 and the port No. 631, for example, according to the information processing unit of the present invention, it becomes possible, while protecting the information processing unit from illegal accesses by closing the port No. 80, to execute the IPP by using the port No. 631. If necessary, it is possible, while protecting the information processing unit from illegal accesses by closing the port No. 631, to execute the IPP by using the port No. 80. It is possible to make both protection and utilization of the individual processing units compatible.

When the plural types of software use one and the same port, it is also possible to provide a setting device that sets validity or invalidity by each of the combinations of the types of software and the ports. In this case, it is possible to set the port No. 80 opened in the communication with the Web server, and to set the port No. 80 closed in the communication with the IPP, although the port number is the same 80. Thus, it becomes possible to manage each of the information processing units in detail.

### BRIEF DESCRIPTION OF THE DRAWINGS

FIG. 1 schematically illustrates a configuration of the information processing unit of the first embodiment;

FIG. 2 schematically illustrates a user interface of the information processing unit of the embodiment:

FIG. 3 shows a flow chart illustrating a processing procedure that the information processing unit of the first embodiment executes;

FIG. 4 schematically illustrates a configuration of the information processing unit of the second embodiment; and

FIG. 5 schematically illustrates a user interface of the information processing unit of the second embodiment.

### DETAILED DESCRIPTION OF THE INVENTION

Important features for implementing the invention will be listed hereunder.

(Feature 1) The software and the network circuit communicate in accordance with TCP or UDP protocol.

(Feature 2) The software communicates with the network circuit by using ports that follow TCP or UDP protocol.

(Feature 3) The information processing unit can set validity or invalidity by each of the combinations of ports and communication directions. As an example, although the port number is the same 80, the setting that the communication toward the information processing unit is made valid and the communication from the information processing unit is made invalid is permitted.

### FIRST EMBODIMENT

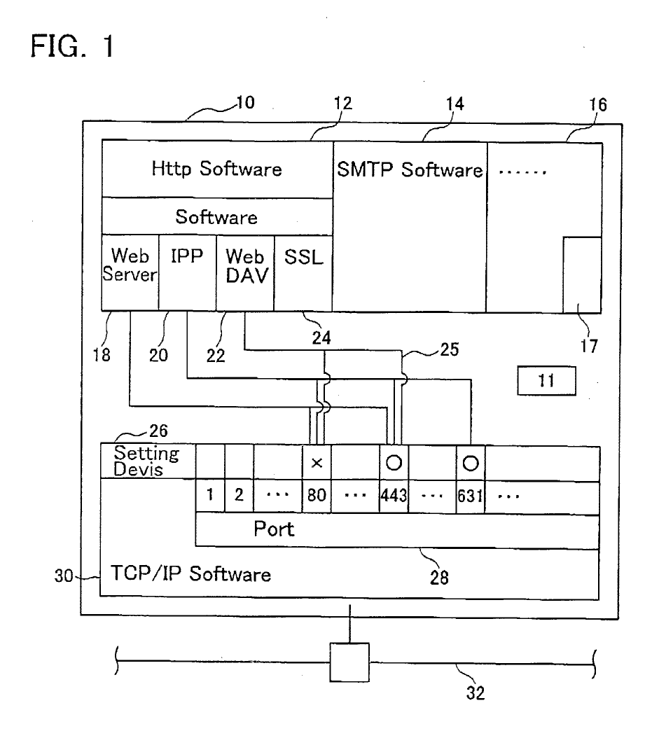

FIG. 1 illustrates a condition wherein an information processing unit 10 is connected to a network circuit 32. The information processing unit 10 stores software 30 that executes TCP/IP protocol. If data transmitted through the network circuit 32 contains the IP address of the information processing unit 10, the software 30 inputs the data into the information processing unit 10. The information processing unit 10 reads a destination port number written in the TCP header of the inputted data, and transmits the inputted data to a port 28 having the read destination port number (the 28 here is not the port number, but a reference number of the ports). When any one of the port 28 transmits data to the network circuit 32, the information processing unit 10 transmits the data to the network, circuit 32 together with an IP address of an information processing unit at a destination of the data being transmitted, information indicating a destination specified by a port number inside the information processing unit of the destination, the IP address of the information processing unit 10 being the source transmitting the data, and information indicating a transmission source specified by a port number inside the information processing unit 10 that transmits the data.

Since all the information processing units connected to the network circuit 32 implement one and the same protocol by the software 30 that executes TCP/IP protocol, it is possible to transmit information from an arbitrary information processing unit to an arbitrary information processing unit.

Various information processing units are connected to the network circuit 32, such as a personal computer (PC), storage computer, printer, and compound system (multi-function system having printer function. FAX function, copy function, scanner friction, and server function, etc.). Each of the information processing units stores the software that realizes each function, and includes the processing device that implements the software.

FIG. 1 illustrates an example case that the information processing unit 10 is a compound system, which stores software 18 called the Web server, software 20 called the IPP, software 22 called WebDAV, software 24 called SSL. Any of the software 18 through 24 is based on http software 12. In addition, the information processing unit 10 stores software based on SMTP software 14 and software based on the other software 16. The usual information processing unit stores plural types of software, and includes a processing device 11 that implements each of the software. The information processing unit 10 stores software 17 that sets validity or invalidity by each of the ports.

As mentioned above, the information processing unit 10 reads the destination port number written in the TCP header of the data inputted from the network circuit 32, and transmits the inputted data to the port 28 having the read destination port number. On one hand, the software has set a port number of the port into which the data are fetched in executing the software. Or, the software sets a port number of the port from which the data is transmitted to the network circuit 32.

In a conventional practice, the software and the port used by the software are in one-to-one correspondence in most cases. Recently however, a piece of software often uses two or more ports. In reverse, one port is often used by two or more software.

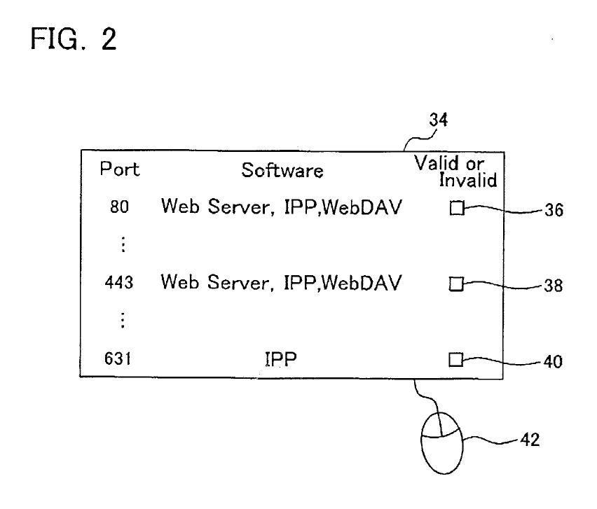

A line 25 in FIG. 1 illustrates a relation between the software and the ports used by the software as an example. In case of FIG. 1, as shown in FIG. 2, the port 80 is used by three types of software called the Web server, IPP, and WebDAV; the port 443 is used also by three types of software called the Web server, IPP, and WebDAV; and the port 631 is used only by the software called IPP.

The information processing unit 10 is provided with the function that sets to permit or inhibit data communication using the port by each of the ports.

FIG. 2 illustrates a screen 34 displayed on the information processing unit 10 as the setting operation starts, which displays a list of executable types of software by the information processing unit 10. Each type of software is associated with port IDs (may be port numbers, or symbols corresponding to individual ports) used by each type of software. Here, the software using each of these ports is extracted from a storage unit that stores each of the software, along with the start of the setting operation. In case of this embodiment, the list sorted by the port D is displayed; the list of the port 80 used by three types of software called the Web server, PP, and WebDAV, the port 443 used by three types of software called the Web server, IPP, and WebDAV, and the port 631 used only by the software called IPP 20 is displayed. The list sorted by the type of software may be displayed.

A user of the information processing unit, a manager, for example, while viewing the screen 34 in FIG. 2, manipulates a mouse 42 and thereby sets to it or inhibit the data communication using a port. To move the cursor into a frame 36 and click the mouse will display a round mark in the frame 36, which permits the data communication using the port 80. In a state that the round mark is displayed in the frame 36, to put the cursor in the frame 36 and click the mouse will turn off the round mark in the frame 36, which inhibits the data communication using the port 80. In other words, the port 80 is closed. In the same manner, to move the cursor into a frame 38 and click the mouse will display a round mark in the frame 38, which permits the data communication using the port 443. In a state that the round mark is displayed in the frame 38, to put the cursor in the frame 38 and click the mouse will turn off the round mark in the frame 38, which inhibits the data communication using the port 443. In other words, the port 443 is closed.

FIG. 1 illustrates a state that the port 80 is closed, the port 443 is opened, and the port 631 is opened by the setting operation. The setting device 26 is realized by the software 17.

The information processing unit is unfortunately exposed to a risk by illegal access. FIG. 1 illustrates a state that an illegal access attacks the port 80 and the port 80 is closed to protect the information processing unit from the illegal access.

Since, in the conventional technique, the port 80 is used by three types of software called the Web server; IPP, and WebDAV, as long as any software is executable, it is impossible to close the port 80. However, in the information processing unit 10 of this embodiment, validity or invalidity can be set by a unit of port.

In consequence, a conventionally impossible operation becomes possible. In case of FIG. 1, the port 80 is closed. Therefore, the Web server cannot communicate with the network circuit 32 via the port 80 for example. However, die Web server uses the port 443 in addition to the port 80, and this port 443 is opened. The Web server is able to execute processing, while communicating with the network circuit 32 via the port 443. While protecting the port 80 from illegal accesses, it is possible to utilize the software called the Web server. Both protection and utilization can be made compatible.

In case there is a necessity of rejecting accesses to the software and maintaining the software working, it is possible to cut off the accesses and maintain the software functioning. Accesses to the software being executed by the information processing unit can be prohibited by setting all ports used by the software invalid. The software itself continues to work without communication with the network circuit 32.

The same can be achieved to the IPP. The IPP ues the port 631 and port 443 in addition to the port 80. Even if the port 80 is closed, the IPP is able to execute processing, while communicating with the network circuit 32 by using the port 631 and the port 443. While protecting the port 80 from illegal accesses, it is possible to utilize the software called the IPP. Both protection and utilization can be made compatible.

The setting device 26 that sets to permit or inhibit a data communication using a port by each port is provided with each of the information processing units; and it is able to set independently the respective setting state of each of the plural information processing units connected to connected to one and the same router through the LAN cable. Therefore, it is possible to manage in detail so as to meet the use of each of the information processing units.

When there are plural information processing units provided with the Web server function inside the LAN, for example, if the port 80 is made invalid by the router interfacing the LAN with the Internet circuit being the outside thereof, the information processing units inside the LAN will not meet the demands being transmitted uniformly from the Internet circuit by using the port 80. It was impossible to set the port 80 valid in one information processing unit and set the port 80 invalid in another information processing unit, thus the usability was not satisfactory.

In the present invention however, without invalidating the port 80 by the router, the port 80 can be set invalid by each of the information processing units that are desirably made invalid; accordingly, the above problem will not appear and the usability is enhanced.

There is a case that same software performs different function depending on a port that the software uses. In this case, necessary function may be maintained by setting the port for the necessary function valid, and unnecessary function may be prohibited by setting the port for the unnecessary function invalid.

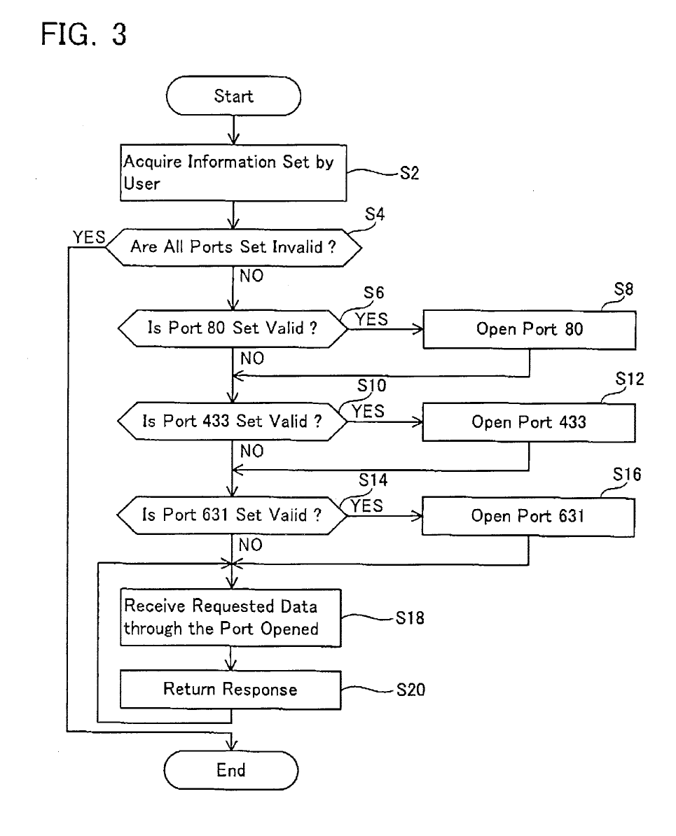

FIG. 3 illustrates a processing procedure that the information processing unit 10 executes. The step S2 acquires information set by the user. In concrete, the state set by the user is acquired by using the interface screen 34 illustrated in FIG. 2.

The step S4 determines whether or not all the ports are set invalid. If all the ports are set invalid, the processing is terminated.

The step S6 determines whether or not the setting to validate the port 80 is made. If the setting to validate the port 80 is made, the step S8 opens (validates) the port 80.

The step S10 determines whether or not the setting to validate the port 443 is made. If the setting to validate the port 443 is made, the step S12 opens the port 443.

The step S14 determines whether or not the setting to validate the port 631 is made. If the setting to validate the port 631 is made, the step S16 opens the port 631.

At the step S18, the software requests the other information processing units to transmit data by way of the validated port and the network circuit 32. As an example, the software requests a PC connected to the network circuit 32 to transmit printing data.

The step S20 returns a response to the other information processing units by way of the validated port and the network circuit 32. As an example, it returns a response that the printing data is satisfactorily received, or a response that the received printing data is finished printing.

Although it is not illustrated in FIG. 1, another setting device (second or additional setting device) may be provided with the information processing unit 10, which switches to permit or inhibit execution of the software by each of the types of software.

With the additional setting device provided, for example, it becomes possible to make the Web server 18 available and make the IPP 20 unavailable.

In case of FIG. 1, for example, both the Web server 18 and the IPP 20 are set so as to use the port No. 80 and the port No. 443, and the port No. 80 is closed. With regard to the Web server 18, Web server 18 may have a character that there is not any problem in executing the software with the port No. 80 closed. With regard to the IPP 20 on the other hand, IPP 20 may have a character that a possibility of malfunction is caused in executing IPP 20 with the port No. 80 closed. In this case, if the second setting device is added that the user's operation switches each of the software into being executable or unexecutable, it will prevent such a malfunction from generating. In the above illustrated case, to make the IPP disable will not cause any problem, even if the Web server is executed with the port No. 80 closed.

There is a case that same software performs different functions depending on a port that the software uses. In this case, although it is possible by providing the second setting device to switch between a condition where execution of the software is permitted and a condition where the execution is inhibited, it is also possible by providing the first setting device to set a condition that a necessary function may be maintained by setting the port for the necessary function valid, and a condition that an unnecessary function may be prohibited by setting the port for the unnecessary function invalid.

### SECOND EMBODIMENT

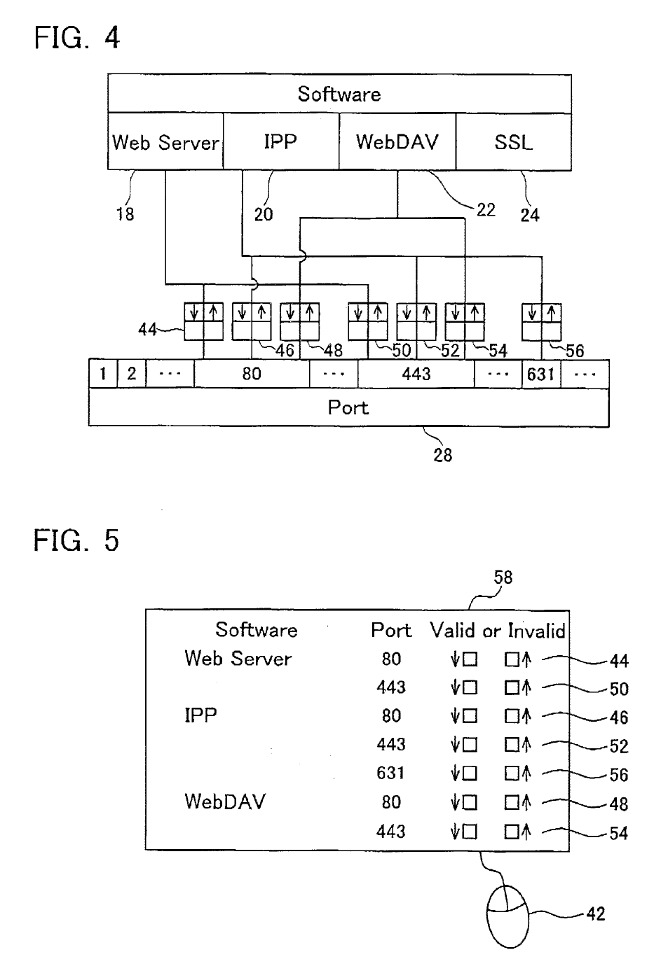

FIG. 4 illustrates a setting device of the second embodiment. Only different points from FIG. 1 are illustrated, and the parts not illustrated in FIG. 4 are the same as FIG. 1.

The second embodiment makes a setting possible to permit or inhibit a data transmission by each of combinations of the types of software and kinds of port.

The symbol 44 in FIG. 4 shows that a setting to permit or inhibit a data transmission by the combination of the Web server and the port 80 is possible. The symbol 46 in FIG. 4 shows that a setting to permit or inhibit a data transmission by the combination of the IPP and the port 80 is possible. In the same manner hereunder, the symbol 56 in FIG. 4 shows that a setting to permit or inhibit a data transmission by the combination of the IPP and the port 631 is possible.

Further, the second embodiment makes a setting possible to permit or inhibit a data transmission by a communication direction. The symbol 44 in FIG. 4 shows that a setting as to whether a data transmission toward the network circuit 32 from the Web server by way of the port 80 is possible or not is allowed, and independently from this, that a setting as to whether a data transmission toward the Web server from the network circuit 32 by way of the port 80 is possible or not is allowed. The symbols 46 through 56 show the same; for example, the symbol 56 shows that a setting as to whether a data transmission toward the network circuit 32 from the IPP by way of the port 631 is possible or not is allowed, and independently from this, that a setting as to whether a data transmission toward the IPP from the network circuit 32 by way of the port 631 is possible or not is allowed.

FIG. 5 illustrates a screen 58 used for the setting operation, showing that a setting to permit or inhibit a data transmission by each combination of the type of software and the kind of port is possible. In FIG. 2, the setting of validity or invalidity is made by each of the ports; on the other hand in FIG. 5, the setting of validity or invalidity is made by each of the combinations of the type of software and the kind of port. As an example, by using a frame 44, to validate the port 80 or not in relation to the Web server can be set; by using a frame 46, to validate the port 80 or not in relation to the IPP can be set; and by using a frame 48, to validate the port 80 or not in relation to the WebDAV can be se Besides, the frames are provided on the left and right; by using the left fares, whether a data transmission toward the network circuit 32 from the port is enabled or not can be set, and by using the right frames, whether a data transmission toward the port from the network circuit 32 is enabled or not can be set.

In the above case, although it is the same port 80, for example, the port can be set opened in the communication with the Web server; and the port can be set closed in the communication with the IPP. Thus, it becomes possible to manage each of the information processing units in detail

The present invention has been described in detail with concrete examples; however these are only illustrations, and they will not confine the scope of the claims of the present application. The disclosed in the scope of the claims includes various modifications and changes of the concrete examples illustrated above. As an example, the network circuit 32 may be a wireless circuit. The illustrated software can be replaced by other software. In the embodiments, the information processing unit was a compound system; however it may be a server, a PC or a storage computer. The information processing unit may be located on the client side, or on the server side.

In the above embodiments, validity or invalidity of a port is set by each of the ports according to the user interface as shown in FIG. 2, and validity or invalidity of a combination of a kind of port and a type of software is set by each of the combinations according to the user interface as shown in, FIG. 5. Alternatively, it is possible to modify the user interface as shown in FIG. 2 in which a user can set validity or invalidity of the combination of the kind of port and the type of software by each of the combinations. Further, it is also possible to modify the user interface as shown in FIG. 2 in which a user can set validity or invalidity of a communication from the network circuit to the information processing unit and set validity or invalidity of a communication from the information processing unit to the network circuit independently.

Further, the technical elements described in the present specification or the drawings display technical usefulness by themselves or various combinations, which are not confined to the combinations of the claims at the time of application. The techniques illustrated in the present specification or the drawings are to accomplish a plurality of objects at the sane time, and to accomplish one object of them in itself embraces the technical usefulness.

What is claimed is:

1. An information processing unit capable of communicating with other information processing units by way of a network circuit, comprising:
a storage device that stores software;
a processing device that executes the software;
a plurality of ports that make communications possible between the software and the network circuit;
a setting device that sets validity or invalidity to each of the ports; and
a controller that, on condition that a port is set valid, validates execution of the software via the port, and on condition that a port is set invalid, invalidates execution of the software via the port, wherein validity or invalidity of execution of the software via a port is controlled by each of the ports.

2. An information processing unit according to claim 1,
the software stored in the storage device makes the information processing unit work as a server.

3. An information processing unit according to claim 1,
the setting device sets validity or invalidity of a communication from the network circuit to the information processing unit by each of the ports, and sets validity or invalidity of a communication from the information processing unit to the network circuit by each of the ports.

4. An information processing unit according to claim 1,
wherein the storage device stores plural types of software,
wherein the information processing unit further comprises a second setting device that sets validity or invalidity of execution of software by each type of the software, and
wherein the controller controls both validity or invalidity of execution of the software by the type of the software and validity or invalidity of the port by each of the ports.

5. An information processing unit according to claim 1,
wherein the setting device is adopted to set validity or invalidity to each of combination of the type of software and the kind of port, and
wherein the controller, on condition that a type of software is set valid and a kind of port is set valid, validates execution of the type of software via the kind of port, on condition that a type of software is set valid and a kind of port is set invalid, invalidates execution of the type of software via the kind of port and validates execution of the type of software via another kinds of ports, and on condition that a type of software is set invalid, invalidates execution of the type of software.

6. An information processing unit according to claim 5,
the setting device sets validity or invalidity of a communication from the network circuit to the information processing unit by each of the combinations, and sets validity or invalidity of a communication from the information processing unit to the network circuit by each of the combinations.

7. A user interface for an information processing unit capable of communicating with other information processing units by way of a network circuit, comprising:
a display device that displays a list of ports included in the information processing unit, each of the ports making communication possible between the network circuit and software to be executed by the information processing unit, and each of the ports being associated with types of software that use the port for communicating with the network circuit; and
an inputting device for a user to select a port from the displayed list and to set validity or invalidity of the selected port.

8. A user interface as defined in claim 7,
wherein the display device displays a communication from the information processing unit to the network circuit and a communication from the network circuit to the information processing unit by each of the ports, and
wherein the inputting device is adopted for the user to select the communication from the information processing unit to the network circuit and/or the communication from the network circuit to the information processing unit, and to set validity or invalidity of the selected communication.

9. A user interface as defined in claim 7,
wherein the inputting device is adopted for the user to set validity or invalidity by each of combination of the kind of port and the type of software.

10. A user interface as defined in claim 9,
wherein the display device displays a communication from the information processing unit to the network circuit and a communication from the network circuit to the information processing unit by each of combination of the kind of port and the type of software, and
wherein the inputting device is adopted for the user to select the communication from the information processing unit to the network circuit and/or the communication from the network circuit to the information processing unit, and to set validity or invalidity of the selected communication.

11. A medium which stores a program that can be read by an information processing unit capable of communicating with other information processing units by way of a network circuit, of which the program makes the information processing unit execute the following processes:
a storing process that stores software;
an operating process that executes the software;
a setting process that sets to a plurality of ports that make communications possible between the software and the network circuit, validity or invalidity by each of the ports; and
a controlling process that, on condition that a port is set valid, validates execution of the software via the port, and on condition that a port is set invalid, invalidates execution of the software via the port wherein validity or invalidity of execution of the software via a port is controlled by each of the ports.

12. A medium according to claim 11,
wherein a program that makes the information processing unit work as a server is stored in the storing process.

13. A medium according to claim 11,
wherein validity or invalidity of a communication from the network circuit to the information processing unit and/or validity or invalidity of a communication from the information processing unit to the network circuit is set by each of the ports in the setting process.

14. A medium according to claim 11,
wherein plural types of software are stored in the storing process,
wherein the program stored in the medium makes the information processing unit execute a second setting process that sets validity or invalidity of execution of software by each type of the software, and
wherein bot validity or invalidity of execution of the software by the type of the software and validity or invalidity of die port by each of the ports are controlled in the controlling process.

15. A medium according to claim 11,
wherein validity or invalidity to each of combination of the type of software and the kind of port is set in the setting process, and
wherein the controlling process, on condition that a type of software is set valid and a kind of port is set valid, validates execution of the type of software via the kind of port, on condition that a type of software is set valid and a kind of port is set invalid, invalidates execution of the type of software via the kind of port and validates execution of the type of software via another kinds of ports, and on condition that a type of software is set invalid, invalidates execution of the type of software.

16. A medium according to claim 15,
wherein validity or invalidity of a communication from the network circuit to the information processing unit and/or validity or invalidity of a communication from the information processing unit to the network circuit is set by each of the combinations in the setting process.

17. A medium which stores a program that can be read by an information processing unit capable of communicating with other information processing units by way of a network circuit, of which the program makes the information processing unit execute the following processes:
a displaying process that displays a list of ports included in the information processing unit, each of the ports making communication possible between the network circuit and software to be executed by the information processing, and each of the ports being associated with types of software that use the port for communicating with the network circuit; and
an setting process that, on condition that a user has added an operation of selecting a port from the displayed list to set validity or invalidity, validates or invalidates the port with the operation added.

18. A medium according to claim 17,
wherein a communication from the information processing unit to the network circuit and a communication from the network circuit to the information processing unit are displayed by each of the ports, and
wherein validity or invalidity is set to the communication from the information processing unit to the network circuit and the communication from the network circuit to the information processing unit respectively based on an operation that the user has added.

19. A medium according to claim 17,
wherein combinations of the kind of port and the type of software are displayed in the displaying process such that the user can select one of the combinations.

20. A medium according to claim 19,
wherein a communication from the information processing unit to the network circuit and a communication from the network circuit to the information processing unit are displayed by each of the combination of the kind of port and the type of software, and
wherein validity or invalidity is set to the communication from the information processing unit to the network circuit and the communication from the network circuit to the information processing unit respectively based on an operation that the user has added.
